(19) United States
(12) Patent Application Publication
(10) Pub. No.: US 2011/0026596 A1
(43) Pub. Date: Feb. 3, 2011

(54) Method and System for Block-Based Motion Estimation for Motion-Compensated Frame Rate Conversion

(76) Inventor: Wei Hong, Richardson, TX (US)

Correspondence Address: TEXAS INSTRUMENTS INCORPORATED, P O BOX 655474, M/S 3999, DALLAS, TX, 75265, US

(21) Appl. No.: 12/510,958

(22) Filed: Jul. 28, 2009

(51) Int. Cl. H04N 7/26

(52) U.S. Cl. 375/240.16; 375/E07.123

(57) ABSTRACT

Methods for coherent block-based motion estimation for motion-compensated frame rate conversion of decoded video sequences are provided. In some of the disclosed methods, motion vectors are estimated for each block in a decoded frame in both raster scan order and reverse raster scan order using prediction vectors from selected spatially and temporally neighboring blocks. Further, in some of the disclosed methods, a spatial coherence constraint that detects and removes motion vector crossings is applied to the motion vectors estimated for each block in a frame to reduce halo artifacts in the up-converted video sequence. In addition, in some of the disclosed methods, post processing is performed on estimated motion vectors to improve the coherence of the motion vectors. This post-processing includes application of vector median filters to the estimated motion vectors for a frame and/or application of a sub-block motion refinement to increase the density of the motion field.

### BACKGROUND OF THE INVENTION

The demand for digital video products continues to increase. Some examples of applications for digital video include video communication, security and surveillance, industrial automation, and entertainment. Further, video applications are becoming increasingly mobile as a result of higher computation power in handsets, advances in battery technology, and high-speed wireless connectivity. Digital video capabilities can be incorporated into a wide range of devices, including, for example, digital televisions, digital direct broadcast systems, wireless communication devices, wireless broadcast systems, personal digital assistants (PDAs), laptop or desktop computers, Internet video streaming devices, digital cameras, digital recording devices, video gaming devices, video game consoles, personal video recorders, etc.

Video compression is an essential enabler for digital video products. Compression-decompression (CODEC) algorithms enable storage and transmission of digital video. Typically codecs are industry standards such as MPEG-2, MPEG-4, H.264/AVC, etc. At the core of all of these standards is the hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block.

To transmit or store digital video, a video encoder using one of the above standards may reduce the number of bits encoded per frame and/or the frame rate (i.e., frames per second) of the digital video to reduce the amount of data to be stored/transmitted. The frame rate reduction may be achieved, for example, by dropping frames prior to encoding. When the encoded video is displayed, a decoder can increase the displayed frame rate (i.e., up-convert the frame rate) of a received/stored low-frame-rate bit stream to a frame rate supported by a display device (e.g., an LCD display, a plasma display, etc.) by creating new frames in-between decoded frames. For example, a decoded may up-convert the frame rate by interpolating (with motion compensation) the decoded frames to create the new in-between frames.

Many different techniques for motion-compensated frame rate conversion of digital video are known. Further, a large percentage of these techniques rely on block-based motion vector (MV) estimation to estimate motion vectors to be used for the motion compensation. The motion vectors estimated using many block-based estimation techniques may not be true motion vectors (i.e., may not represent the movement of objects) and thus the motion field is incoherent. If such motion vectors are used for motion-compensated frame rate conversion, artifacts such as halo effect, distortion, etc., may occur in the resulting displayed video. Accordingly, improvements in motion estimation for motion-compensated frame rate conversion in order to improve the quality of displayed images are desirable.

### SUMMARY OF THE INVENTION

In general, in one aspect, the invention relates to a computer-implemented method of block-based motion vector estimation, the method including estimating a first motion vector for each block of a row of a decoded frame of a video sequence in raster scan order, estimating a second motion vector for each block in the row in reverse raster scan order, and for each block in the row, selecting the first motion vector estimated for the block or the second motion vector estimated for the block as a motion vector for the block based on a sum of absolute differences (SAD) for the first motion vector and the second motion vector.

In general, in one aspect, the invention relates to a computer-implemented method of block-based motion vector estimation, the method including estimating motion vectors for each block of a decoded frame of a video sequence, and applying a spatial coherence constraint that removes motion vector crossings to the estimated motion vectors to produce spatially coherent motion vectors.

In general, in one aspect, the invention relates to a digital system that includes a motion vector generation component configured to generate motion vectors for a decoded frame of a video sequence by estimating motion vectors for each block of the decoded frame, and for each block, estimating motion vectors for each sub-block of the block using a plurality of prediction vectors, wherein the plurality of prediction vectors includes the motion vector estimated for the block and the motion vectors estimated for blocks immediately surrounding the block in the decoded frame.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIG. 2 shows a flow diagram of a method for motion estimation in accordance with one or more embodiments of the invention;

FIG. 3 shows an example illustrating block-based motion estimation in accordance with one or more embodiments of the invention;

FIGS. 4A-4D show examples illustrating a spatial coherence constraint on a motion vector in accordance with one or more embodiments of the invention;

FIG. 5 shows an example of application of the spatial coherence constraint in accordance with one or more embodiments of the invention;

FIG. 6 shows an example of application of filtering to motion vectors in accordance with one or more embodiments of the invention;

FIG. 7 shows an example illustrating sub-block refinement of a motion vector in accordance with one or more embodiments of the invention;

FIG. 8 shows an example of application of sub-block refinement to motion vectors in accordance with one or more embodiments of the invention; and

FIG. 9 shows an illustrative digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to. . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, combined, and/or performed in a different order than the order shown in the figures and/or described herein. Accordingly, embodiments of the invention should not be considered limited to the specific ordering of steps shown in the figures and/or described herein.

In general, embodiments of the invention provide methods and systems for coherent block-based motion estimation for motion-compensated frame rate conversion. More specifically, embodiments of the invention estimate motion vectors for blocks of decoded frames of a video sequence with improved spatial and temporal coherence as compared to prior art estimation techniques. These motion vectors may then be used to perform motion-compensated frame rate conversion on the video sequence prior to displaying the video sequence. In some embodiments of the invention, motion vectors are estimated for each block in a decoded frame in both raster scan order and reverse raster scan order using prediction vectors from selected spatially and temporally neighboring blocks. Computing the motion vectors in both raster scan order and reverse raster scan order improves the motion estimates for the blocks as motion is propagated from top-left to bottom-right of the frame and from top-right to bottom-left of the frame. Thus, the detection of object motion from right-to-left in a frame may be better than that of prior art approaches that only compute the motion vectors in raster scan order, especially for small or irregular objects. In addition, the use of prediction vectors from selected spatially and temporally neighboring blocks increases the coherence of the estimated motion vectors.

In some embodiments of the invention, a spatial coherence constraint is applied to the motion vectors estimated for each block in a frame to reduce halo artifacts in the video sequence. This spatial coherence constraint detects and removes motion vector crossings. Further, in some embodiments of the invention, post processing is performed on the estimated motion vectors to further improve the coherence of the motion vectors. More specifically, a cascade of vector median filters may be applied to the estimated motion vectors for a frame and/or a sub-block motion refinement may be applied to increase the density of the motion field.

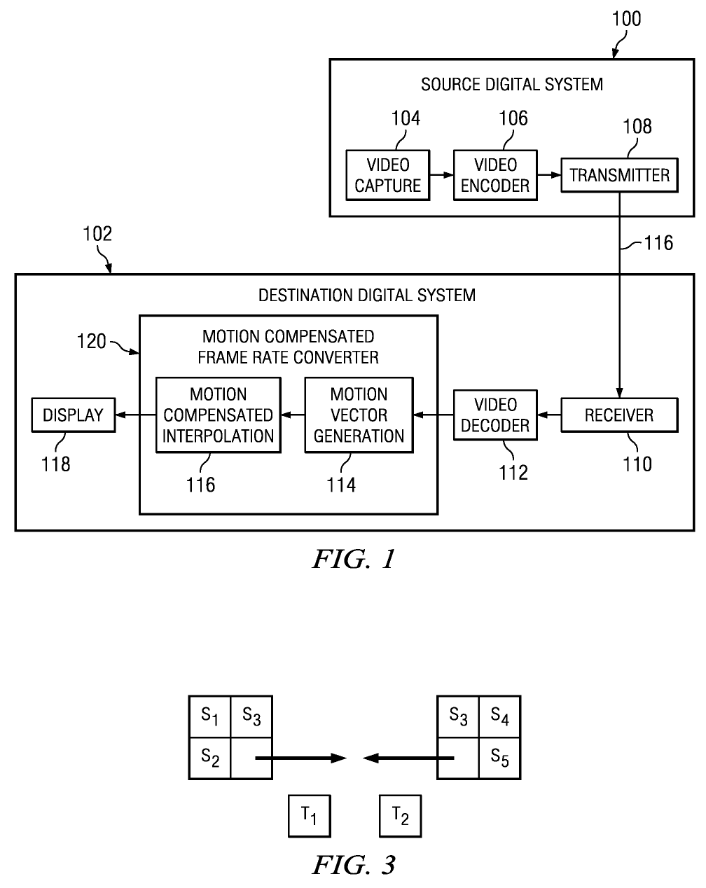

FIG. 1 shows a block diagram of a video encoding/decoding system in accordance with one or more embodiments of the invention. The video encoding/decoding system performs motion-compensated frame rate conversion of encoded digital video sequences using embodiments of the methods for block-based motion estimation described herein. The system includes a source digital system (100) that transmits encoded video sequences to a destination digital system (102) via a communication channel (116). The source digital system (100) includes a video capture component (104), a video encoder component (106) and a transmitter component (108). The video capture component (104) is configured to provide a video sequence to be encoded by the video encoder component (106) or, if the video sequence is suitably encoded, to provide the video sequence to the transmitter component (108). The video capture component (104) may be for example, a video camera, a video archive, or a video feed from a video content provider. In some embodiments of the invention, the video capture component (104) may generate computer graphics as the video sequence, or a combination of live video and computer-generated video.

The video encoder component (106) receives a video sequence from the video capture component (104) and encodes it for transmission by the transmitter component (1108). In general, the video encoder component (106) performs the encoding in accordance with a video encoding standard such as, for example, the MPEG-x and H.26x video encoding standards. In operation, the video encoder component (106) receives the video sequence from the video capture component (104) as a sequence of video frames, divides the frames into coding units which may be a whole frame or a slice of a frame, divides the coding units into blocks of pixels, and encodes the video data in the coding units based on these blocks. During the encoding process, the frame rate of the video sequence may be reduced.

The transmitter component (108) transmits the encoded video sequence to the destination digital system (102) via the communication channel (116). The communication channel (116) may be any communication medium, or combination of communication media suitable for transmission of the encoded video sequence, such as, for example, wired or wireless communication media, a local area network, or a wide area network.

The destination digital system (102) includes a receiver component (110), a video decoder component (112), a motion compensated frame rate converter component (120), and a display component (118). The receiver component (110) receives the encoded video sequence from the source digital system (100) via the communication channel (116) and provides the encoded video sequence to the video decoder component (112) for decoding. In general, the video decoder component (112) reverses the encoding process performed by the video encoder component (106) to reconstruct the frames of the video sequence. Motion-compensated frame rate conversion is then performed, if needed, on the reconstructed frames to increase the frame rate prior to display on the display component (114). The display component (114) may be any suitable display device such as, for example, a plasma display, a liquid crystal display (LCD), a light emitting diode (LED) display, etc.

The motion-compensated frame rate conversion is performed by the motion compensated frame rate converter component (120). The motion compensated frame rate converter (120) includes a motion vector generation component (114) and a motion compensated interpolation component (116). The motion vector generation component (114) receives the reconstructed (i.e., decoded) frames from the video decoder component (112) and estimates motion vectors for the blocks of the decoded frames using an embodiment of the methods for motion estimation described herein. The resulting motion vectors are then provided to the motion compensated interpolation component (116). The motion compensated interpolation component (116) uses the motion vectors and the decoded frames to interpolate frames between the decoded frames in order to increase the frame rate of the decoded video sequence. The up-converted video sequence is then provided to the display component (118). The motion compensated interpolation performed by the motion compensated interpolation component (116) may use any suitable interpolation technique based on motion vectors. One such technique is described in U.S. Patent Application No. 2009/0174812 entitled “Motion-Compensated Temporal Interpolation.”

In some embodiments of the invention, the source digital system (100) may also include a receiver component and a video decoder component and/or the destination digital system (102) may include a transmitter component and a video encoder component for transmission of video sequences both directions for video steaming, video broadcasting, and video telephony. Further, the video encoder component (106) and the video decoder component (112) perform encoding and decoding in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), etc.

The video encoder component (106), the video decoder component (112), the motion vector generation component (114), and the motion compensated interpolation component (116) may be implemented in any suitable combination of software, firmware, and hardware, such as, for example, one or more digital signal processors (DSPs), microprocessors, discrete logic, application specific integrated circuits (ASICs), field programmable gate arrays (FPGAs), etc. Further, the source digital system (100) and the destination digital system may be any digital system equipped to send and/or receive digital video, including, for example, a digital television, a digital direct broadcast system, a wireless communication device, a wireless broadcast system, a personal digital assistant (PDAs), a laptop or desktop computer, an Internet video streaming device, a digital camera, a vehicle entertainment center, a digital recording device, a video gaming device, a video game console, a personal video recorder, a set-top box, etc.

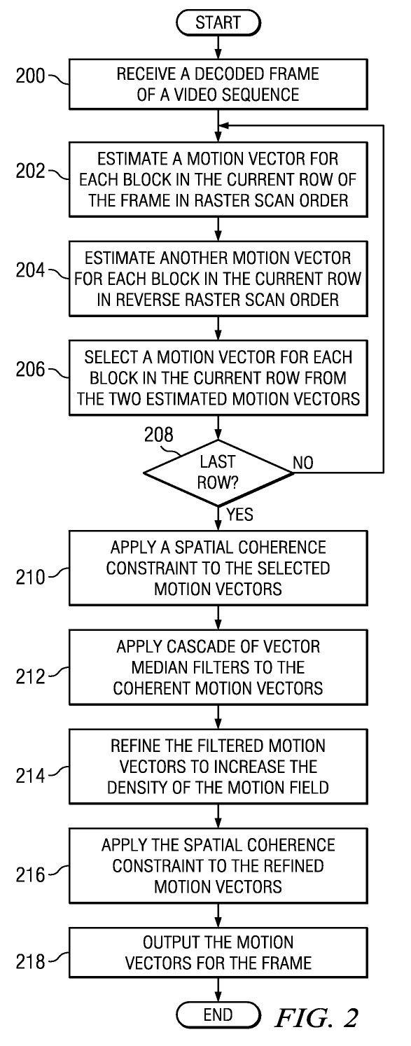

FIG. 2 shows a method for coherent block-based motion estimation in accordance with one or more embodiments of the invention. Initially, a decoded frame of a video sequence is received (200). The decoded frame (i.e., the current frame) is divided into a number of blocks of pixels and motion vectors for each block are then computed as described herein. In one or more embodiments of the invention, the received frame is divided into 8×8 pixel blocks.

To compute the motion vectors, first motion vectors for the blocks are estimated on a row by row basis in raster scan order (left to right) and reverse raster scan order (right to left) (202-208). That is, when the current frame is divided into blocks, the frame may then be viewed as being made up of rows of the blocks. Motion vectors for the blocks in one row are then generated before the motion vectors for the blocks in the next row are generated. More specifically, as shown in FIG. 2, a motion vector is estimated for each block in a current row of the frame in raster scan order (202). Then, another motion vector is estimated for each block in the current row in reverse raster scan order (204). In other words, moving from left to right in the current row and then from right to left, a motion vector is estimated for each block based on selected prediction vectors. The prediction vectors include previously computed motion vectors for selected spatially and temporally neighboring blocks, if these previously computed motion vectors are available. Using both spatial and temporal motion vectors to estimate a motion vector increases the coherence of the estimated motion vector. A spatially neighboring block is a block in the current frame and a temporally neighboring block is a block in the previous frame.

In one or more embodiments of the invention, the global motion vector of the previous frame and/or a randomly chosen vector may also be used as prediction vectors in estimating a motion vector for each block in the current frame. The selection of the randomly chosen vector in embodiments of the invention is explained below. A global motion vector of a frame is the most dominate motion vector in the frame. The global motion vector for the previous frame may be computed using any suitable technique for determined a global motion vector, such as, for example, sorting the block motion vectors for the frame into the bins of a histogram and computing the global motion vector as the center of the bin with the most motion vectors.

In one or more embodiments of the invention, as shown in the example of FIG. 3, the selected prediction vectors used to estimate the motion vector for a block (i.e., the current block) in the current row when blocks are processed in raster scan order include the previously computed motion vectors, if available, for three spatially neighboring blocks and one temporally neighboring block. The selected spatially neighboring blocks are the block immediately to the left of the current block in the current row (S₂), the block in the previous row that is immediately above the current block (S₃), and the block in the previous row that is immediately above and to the left of the current block (S₁). The selected temporally neighboring block is the block in the previous frame that is two blocks to the right and two rows down from the block in the location in the previous frame corresponding to the current block (T₁).

In one or more embodiments of the invention, as shown in the example of FIG. 3, the selected prediction vectors used to estimate the motion vector for a block (i.e., the current block) in the current row when blocks are processed in reverse raster scan order include the previously computed motion vectors, if available, for three spatially neighboring blocks and one temporally neighboring block. The selected spatially neighboring blocks are the block immediately to the right of the current block in the current row (S₅), the block in the previous row that is immediately above the current block (S₃), and the block in the previous row that is immediately above and to the right of the current block (S₄). The selected temporally neighboring block is the block in the previous frame that is two blocks to the left and two blocks down from the block in the location in the previous frame corresponding to the current block (T₂).

A prediction vector may not be available for a selected spatially neighboring block or for a selected temporally neighboring block depending on the position of the block for which the motion vector is being estimated. For example, if the block for which the motion vector is being estimated is at the left edge of the frame, a previously computed motion vector (i.e., a prediction vector) for a spatially neighboring block immediately to the left of the block in the row will not be available. Similarly, a previously computed motion vector for a temporally neighboring block in the previous frame that is located two blocks to the left and two rows down from a correspondingly located block in the previous frame will not be available. When a previously computed motion vector is not available for a selected block, the motion vector for the current block is estimated using the prediction vectors that are available.

Referring again to FIG. 2, as the motion vectors for each block in the current row are estimated moving in raster scan order (202), the prediction vector of the selected prediction vectors that provides the best, i.e., minimum, SAD (sum of absolute differences) is selected as an estimate for the motion vector for each block. Similarly, as the motion vectors for each block are estimated moving in reverse raster scan order (204), the prediction vector that provides the minimum SAD is selected as another estimate of the motion vector for each block. Then, the best motion vector for each block is selected from the two estimated motion vectors (206), i.e., the estimated motion vector chosen from the raster scan processing and the estimated motion vector chosen from the reverse raster scan processing.

More specifically, in both raster scan order and reverse raster scan order, the SAD of the current block and a block in a search window of reference data (i.e., data from one or more previously processed frames) is computed for each of the available selected prediction vectors. For each selected prediction vector, the block in the reference data that is used for the SAD computation is found by offsetting the block in the previous frame having the same relative location as the current block by the prediction vector. When an SAD for all available prediction vectors for a block in both raster scan and reverse raster scan order has been computed, the prediction vector corresponding to the minimum SAD is chosen as the estimate of the motion vector for the current block.

In one or more embodiments of the invention, a random small vector is added to some of the prediction vectors prior to offsetting the block in the previous frame. More specifically, a random vector is added to the prediction vector from the selected spatially neighboring and temporally neighboring prediction vectors. In those embodiments in which the global motion vector from the previous frame is also used as a prediction vector, a random vector is also added to the global motion vector. In some embodiments of the invention, the random small vector is chosen randomly from a table of empirically determined vectors. Further, a random vector selection may be made for each prediction vector. In some embodiments of the invention, the random small vector is a sum of two small vectors, each chosen randomly from two tables of empirically determined vectors. Further, a random vector selection from each table may be made for each prediction vector. In one or more embodiments of the invention, the two tables used have elements as shown in Table 1 and Table 2 below. In those embodiments in which a random vector is also used as a prediction vector, the random vector may be selected from the single table of empirically determined vectors or may be computed as the sum of two vectors randomly selected from the two tables. Further, the random vector to be included in the prediction vectors for a block may be selected each time a motion vector is estimated for the block.

TABLE 1

[(1 0), (−1 0), (0 2), (0 −2), (3 0), (−3 0), (0 1), (0 −1), (2 0), (−2 0),
(0 3), (0 −3), (0 0)]

TABLE 2

[(0 0), (0 ¼), (0 −¼), (¼ 0), (−¼ 0)]

In one or more embodiments of the invention, the steps of estimating a motion vector for each block in raster scan order (202), estimating another motion vector for each block in reverse raster scan order (204), and selecting the best motion vector (206) are repeated more than once before the next row is processed. The number of iterations performed may be selected based on a tradeoff between improvement in the estimated motion vectors and time. Experiments have shown that the estimated motion vectors in a row will converge after three or four iterations.

After motion vectors are estimated for all blocks in all rows (208), a spatial coherence constraint is applied to the motion vectors (210) to remove motion vector crossings in the frame. More specifically, when the motion vectors of two neighboring blocks cross, one of the motion vectors is modified to eliminate the crossing. In one or more embodiments of the invention, the spatial coherence constraint described below is applied in raster scan order to the motion vectors of each block in the frame to remove motion vector crossings in the frame.

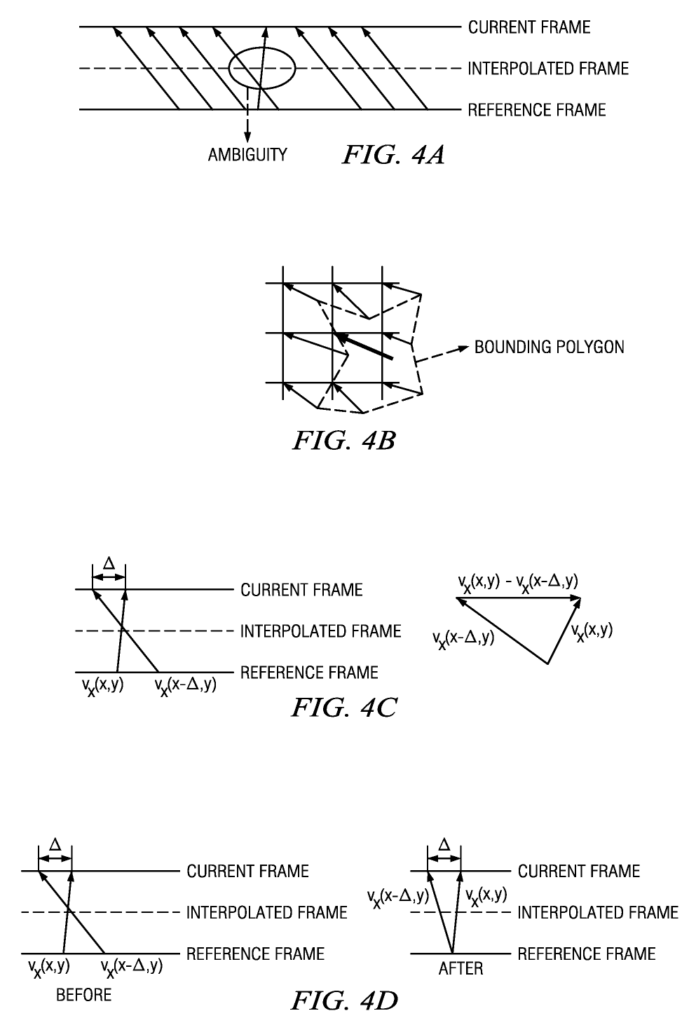

Without the spatial coherence constraint, the motion vectors of neighboring blocks can cross each other and cause ambiguity when used to interpolate frames for frame rate conversion. A 1-D example is shown in FIG. 4A. In this example, the background is moving from right to left and a thin object is moving from left to right slowly. There is ambiguity at the crossing of the two motion vectors which will cause a halo artifact for the thin object in the video sequence after frame rate conversion is performed. Removing the vector crossing in the motion field will remove the ambiguity and thus remove the halo artifact.

To avoid vector crossings in 2-D space, each motion vector should be inside the bounding polygon spanned by the motion vectors of the eight blocks surrounding it as shown in FIG. 4B. However, detecting whether or not a vector is inside a bounding polygon is very complicated. In one or more embodiments of the invention, two 1-D constraints, one in the x (i.e., horizontal) direction and one in the y (i.e., vertical) direction, are used to approximate the 2-D constraint, i.e., the constraint that a motion vector is bounded by the polygon. In the discussion below, a motion vector at location (x,y) is denoted as v(x,y) and vₓ(x,y) and v_{y}(x,y) are the horizontal and vertical components of v(x,y) respectively. The block size of the motion estimation is denoted as Δ, v(x−Δ,y) is the motion vector of the block immediately to the left of the block at (x,y), and v(x,y−Δ) is the motion vector of the block immediately above the block at (x,y).

For the x (i.e., horizontal) direction, as shown in FIG. 4C and Eq. (1), a vector crossing is detected if the difference between the horizontal component of a block vₓ(x,y) (i.e., a current block) and horizontal component of the block immediately to the left of the block vₓ(x−Δ,y) is greater than the block size Δ.

vₓ(x,y)−vₓ(x−Δ,y)>Δ (1)

If a vector crossing is detected in the x direction, the crossing may be removed by modifying either vₓ(x,y) or vₓ(x−Δ,y) to satisfy the condition in Eq. (1). Similarly, for the y direction, a vector crossing is detected if the difference between the vertical component of a block v_{y}(x,y) and vertical component of the block immediately above the block v_{y}(x,y−Δ) is greater than the block size Δ.

v_{y}(x,y)−v_{y}(x,y−Δ)>Δ (2)

If a vector crossing is detected in the y direction, the crossing may be removed by modifying either v_{y}(x,y) or v_{y}(x,y−Δ) to satisfy the condition in Eq. (2).

Studies have shown that people are more likely to focus on a still or slow moving object than on a fast moving object. Therefore, preserving the motion vectors of still or slow moving objects is important to achieve better image quality. Accordingly, in one or more embodiments of the invention, the longer of the two crossing motion vectors is pruned, i.e., shortened, by the block size Δ. The length of a motion vector in x direction is the absolute value of the x component of the vector and the length of the vector in y direction is the absolute value of the y component of the vector.

Table 3 below shows pseudo code for detecting the crossing of two motion vectors in the x direction and the pruning of the longer motion vector in the x direction in accordance with one or more embodiments of the invention. Table 4 below shows pseudo code for detecting the crossing of two motion vectors in the y direction and the pruning of the longer motion vector in the y direction in accordance with one or more embodiments of the invention. FIG. 4D illustrates the result of applying the spatial coherence constraint as shown in Table 3 and Table 4 to the example of FIG. 4C. In this example, vₓ(x−Δ,y) is longer vₓ(x,y), so vₓ(x−Δ,y) is chosen for pruning.

TABLE 3

if vₓ(x,y) − vₓ(x−Δ,y) > Δ

if |vₓ(x,y)| > |vₓ(x−Δ,y)|

vₓ(x,y) = vₓ(x−Δ,y) + Δ

else

vₓ(x−Δ,y) = vₓ(x,y) − Δ

endif

endif

TABLE 4

if v_{y}(x,y) − v_{y}(x,y−Δ) > Δ

if |v_{y}(x,y)| > |v_{y}(x,y−Δ)|

v_{y}(x,y) = v_{y}(x,y−Δ) + Δ

else

v_{y}(x,y−Δ) = v_{y}(x,y) − Δ

endif

endif

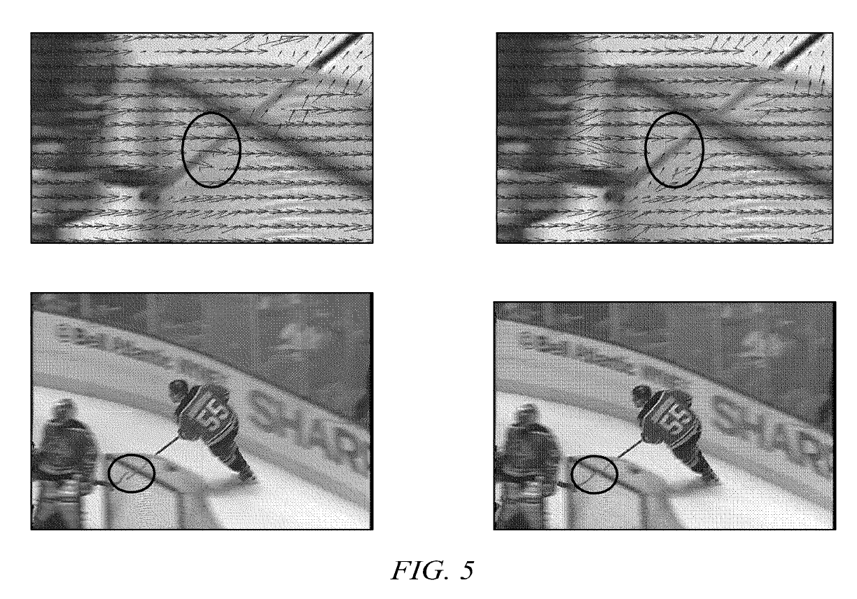

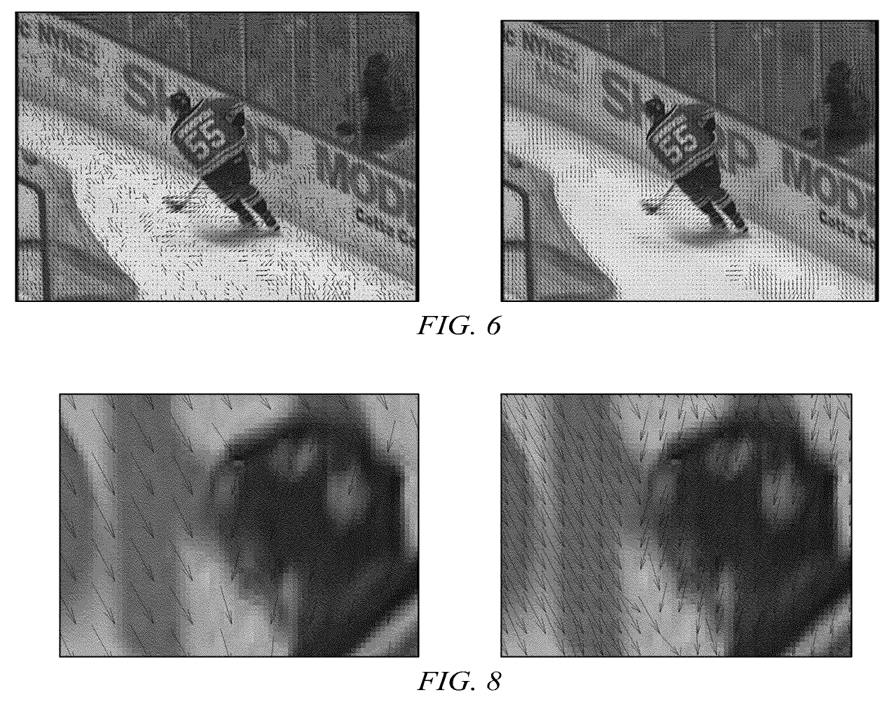

FIG. 5 shows an example of applying the spatial coherence constraint to a video frame. The arrows in the top-left image show the motion field estimated without application of the spatial coherence constraint. Note that there are numerous motion vector crossings, especially inside the circled area. The top-right image shows the motion field estimated with application of the spatial coherence constraint. Note that the vector crossings inside the circled area are gone. The two bottom images show, respectively, the interpolated frames using the two motion fields. The one on the left has strong halo artifact on the hockey stick while the halo effect is largely removed in the image on the right.

In one or more embodiments of the invention, the spatial coherence constraint is applied during the estimation of motion vectors for each row (202, 204) rather than after all motion vectors are estimated for all blocks in the frame. More specifically, after a motion vector is selected for each block in the current row (206), the spatial coherence constraint is applied in raster scan order to the estimated motion vectors in the current row.

After the spatial coherence constraint is applied to the motion vectors for the frame (210), a cascade, i.e., a series, of 2D vector median filters is applied to the motion vectors to remove any outliers in the motion field, i.e., to further improve the coherence of the motion vectors. An outlier is a motion vector with a large difference in length or direction as compared to the surrounding motion vectors. In general, a 2D vector median filter replaces the motion vector for a block with a vector having an x value that is the median of the x values of the motion vectors in a 2D area of blocks in which the motion vector is the center block and having a y value that is the median of the y values of the motion vectors in the 2D block. In one more embodiments of the invention, two 3×3 2D vector median filters are applied sequentially to the motion vectors in the frame. FIG. 8 shows an example of the motion field of a video frame before and after the application of a sequence of two 3×3 2D vector median filters. Note that the application of the filters improved the coherence of the motion field.

After the motion vectors are filtered (212), the motion vectors are refined to increase the density of the motion field. Depending on the size of the blocks used for motion estimation, the motion field after the vector median filters are applied may still be too rough at object boundaries. Accordingly, a motion refinement is applied to obtain a denser motion field, i.e., to generate motion vectors at a sub-block level. More specifically, each block in the frame is divided into sub-blocks and a motion vector is estimated for each sub-block. For example, if the block size used to estimate the motion vectors is 8×8, each block may be divided into four 2×2 sub-blocks and motion vectors estimated for each of the 2×2 sub-blocks. Further, to reduce computational complexity in computing motion vectors for the sub-blocks, the motion vectors of blocks surrounding a block undergoing refinement and the motion vector of the block are used as the prediction vectors for each sub-block.

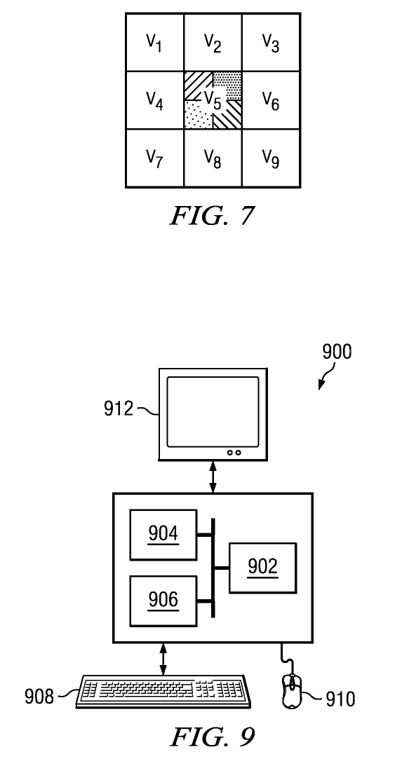

For example, as shown in FIG. 7, block V₅ is divided into four sub-blocks. For each sub-block, the SAD of the sub-block and a sub-block in a search window of reference data (i.e., data from one or more previously processed frames) is computed using each of the motion vectors of the nine blocks as prediction vectors. For each prediction vector, the sub-block in the reference data that is used for the SAD computation is found by offsetting the sub-block in the previous frame having the same relative location as the sub-block by the prediction vector. When an SAD for all nine prediction vectors for a block has been computed, the prediction vector corresponding to the minimum SAD is chosen as the estimate of the motion vector for the sub-block. If any of the nine prediction vectors is not available, the motion vector for the sub-block is estimated using those prediction vectors that are available. FIG. 8 shows an example of the motion field of a video frame before and after the motion refinement is applied.

Referring again to FIG. 2, the spatial coherence constraint is applied to the motion vectors resulting from the motion refinement (218). The resulting motion vectors are then output (218) for use in frame rate conversion of the video sequence.

Embodiments of the methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing including embodiments of the methods for block-based motion compensated frame rate conversion described herein. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

Embodiments of the methods described herein may be implemented in hardware, software, firmware, or any combination thereof. If implemented at least partially in software, the software may be executed in one or more processors, such as a microprocessor, application specific integrated circuit (ASIC), field programmable gate array (FPGA), or digital signal processor (DSP). The software embodying the methods may be initially stored in a computer-readable medium (e.g., memory, flash memory, a DVD, etc.) and loaded and executed in the processor. Further, the computer-readable medium may be accessed over a network or other communication path for downloading the software. In some cases, the software may also be provided in a computer program product, which includes the computer-readable medium and packaging materials for the computer-readable medium.

Embodiments of the methods and systems for block-based motion estimation and motion-compensated frame rate conversion described herein may be implemented in virtually any type of digital system (e.g., a desk top computer, a laptop computer, a handheld device such as a mobile (i.e., cellular) phone, a personal digital assistant, a digital television, a vehicle entertainment center, a digital camera, etc.) with functionality to display digital video sequences. For example, as shown in FIG. 9A, a digital system (900) includes a processor (902), associated memory (904), a storage device (906), and numerous other elements and functionalities typical of digital systems (not shown). In one or more embodiments of the invention, the digital system (900) may include multiple processors and/or one or more of the processors may be digital signal processors. The digital system (900) may also include input means, such as a keyboard (908) and a mouse (910) (or other cursor control device), and output means, such as a monitor (912) (or other display device). The digital system (900) may also include an image capture device (not shown) that includes circuitry (e.g., optics, a sensor, readout electronics) for capturing digital video sequences. The digital system (900) may be connected to a network (e.g., a local area network (LAN), a wide area network (WAN) such as the Internet, a cellular network, any other similar type of network and/or any combination thereof) via a network interface connection (not shown) and may receive encoded digital video sequences via the network. Those skilled in the art will appreciate that these input and output means may take other forms.

Software instructions to perform embodiments of the invention may be stored on a computer readable medium such as a compact disc (CD), a diskette, a tape, a file, memory, or any other computer readable storage device. The software instructions may be distributed to a digital system such as, for example, the digital system of FIG. 9, via removable memory (e.g., floppy disk, optical disk, flash memory, USB key) and/or via a communication path from another system that includes the computer readable medium.

While the invention has been described with respect to a limited number of embodiments, those skilled in the art, having benefit of this disclosure, will appreciate that other embodiments can be devised which do not depart from the scope of the invention as disclosed herein. For example, instead of generating the initial estimate for the block motion vectors on a row by row basis, motion vectors may be generated for each block in the entire frame in raster scan order and then for each block in the entire frame in reverse raster scan order prior to selecting the best motion vector for each block. In another example, motion vectors for each block may also be estimated in vertical bi-directional scan order as well as horizontal bi-directional scan order to improve the motion estimation. Accordingly, the scope of the invention should be limited only by the attached claims.

It is therefore contemplated that the appended claims will cover any such modifications of the embodiments as fall within the true scope and spirit of the invention.

What is claimed is:

1. A computer-implemented method of block-based motion estimation comprising:
estimating a first motion vector for each block of a row of a decoded frame of a video sequence in raster scan order;
estimating a second motion vector for each block in the row in reverse raster scan order; and
for each block in the row, selecting the first motion vector estimated for the block or the second motion vector estimated for the block as a motion vector for the block based on a sum of absolute differences (SAD) for the first motion vector and the second motion vector.

2. The computer-implemented method of claim 1, wherein
estimating a first motion vector further comprises estimating the first motion vector for a first block using a first plurality of prediction vectors comprising motion vectors of a first plurality of spatially neighboring blocks of the first block and a motion vector of at least one first temporally neighboring block; and
estimating a second motion vector further comprises estimating the second motion vector for the first block using a second plurality of prediction vectors comprising motion vectors of a second plurality of spatially neighboring blocks of the first block and a motion vector of at least one second temporally neighboring block.

3. The computer-implemented method of claim 2, wherein the first plurality of spatially neighboring blocks comprises a block in the row immediately to the left of the first block, a block in a previous row immediately above the first block, and a block in the previous row immediately above and to the left of the first block and the second plurality of spatially neighboring blocks comprises a block in the row immediately to the right of the first block, the block in the previous row immediately above the first block, and a block in the previous row immediately above and to the right of the first block.

4. The computer-implemented method of claim 1, further comprising applying a spatial coherence constraint that removes motion vector crossings to the motion vectors selected for the blocks to produce spatially coherent motion vectors.

5. The computer-implemented method of claim 4, wherein applying a spatial coherence constraint comprises:
determining whether a horizontal crossing exists between a first motion vector and a second motion vector of the selected motion vectors, wherein the first motion vector is a motion vector of a first block and the second motion vector is a motion vector of a block immediately to the left of the first block;
when the horizontal crossing exists, modifying a horizontal component of the first motion vector or a horizontal component of the second motion vector to remove the horizontal crossing;
determining whether a vertical crossing exists between the first motion vector and a third motion vector, wherein the third motion vector is a motion vector of a block immediately above the first block; and
when the vertical crossing exists, modifying a vertical component of the first motion vector or a vertical component of the third motion vector to remove the vertical crossing.

6. The computer-implemented method of claim 4, further comprising applying a cascade of vector median filters to the spatially coherent motion vectors.

7. The computer-implemented method of claim 1, further comprising estimating motion vectors for sub-blocks of a block using a plurality of prediction vectors for each sub-block, wherein the plurality of prediction vectors comprises a motion vector of the block and motion vectors of blocks immediately surrounding the block in the decoded frame.

8. A computer-implemented method of block-based motion estimation comprising:
estimating motion vectors for each block of a decoded frame of a video sequence; and
applying a spatial coherence constraint that removes motion vector crossings to the estimated motion vectors to produce spatially coherent motion vectors.

9. The computer-implemented method of claim 8, wherein applying a spatial coherence constraint comprises:
determining whether a horizontal crossing exists between a first motion vector and a second motion vector of the estimated motion vectors;
when the horizontal crossing exists, modifying a horizontal component of the first motion vector or a horizontal component of the second motion vector to remove the horizontal crossing;
determining whether a vertical crossing exists between the first motion vector and a third motion vector; and
when the vertical crossing exists, modifying a vertical component of the first motion vector or a vertical component of the third motion vector to remove the vertical crossing.

10. The computer-implemented method of claim 9, wherein the first motion vector is a motion vector of a first block, the second motion vector is a motion vector of a block immediately to the left of the first block, and the third motion vector is a motion vector of a block immediately above the first block.

11. The computer-implemented method of claim 9, wherein
modifying a horizontal component comprises pruning a longer of the horizontal component of the first motion vector or the horizontal component of the second motion vector, and
modifying a vertical component comprises pruning a longer of the vertical component of the first motion vector or the vertical component of the third motion vector.

12. The computer-implemented method of claim 9, wherein
the horizontal crossing exists when a difference between the horizontal component of the first motion vector and the horizontal component of the second motion vector is greater than a horizontal block size, and
the vertical crossing exists when a difference between the vertical component of the first motion vector and the vertical component of the third motion vector is greater than a vertical block size.

13. The computer-implemented method of claim 8, wherein estimating motion vectors for each block comprises:
estimating a first motion vector for each block of a row of the decoded frame in raster scan order;
estimating a second motion vector for each block in the row in reverse raster scan order; and
for each block in the row, selecting the first motion vector estimated for the block or the second motion vector estimated for the block as a motion vector for the block based on a sum of absolute differences (SAD) for the first motion vector and the second motion vector.

14. The computer-implemented method of claim 8, further comprising estimating motion vectors for sub-blocks of a block using a plurality of prediction vectors for each sub-block, wherein the plurality of prediction vectors comprises a motion vector of the block and motion vectors of blocks immediately surrounding the block in the decoded frame, and wherein estimating motion vectors for sub-blocks is performed after applying a spatial coherence constraint.

15. A digital system comprising:
a motion vector generation component configured to generate motion vectors for a decoded frame of a video sequence by
estimating motion vectors for each block of the decoded frame; and
for each block, estimating motion vectors for each sub-block of the block using a plurality of prediction vectors, wherein the plurality of prediction vectors comprises the motion vector estimated for the block and the motion vectors estimated for blocks immediately surrounding the block in the decoded frame.

16. The digital system of claim 15, wherein estimating motion vectors for each block comprises:
estimating a first motion vector for each block of a row of the decoded frame in raster scan order;
estimating a second motion vector for each block in the row in reverse raster scan order; and
for each block in the row, selecting the first motion vector estimated for the block or the second motion vector estimated for the block as a motion vector for the block based on a sum of absolute differences (SAD) for the first motion vector and the second motion vector.

17. The digital system of claim 15, wherein the motion vector generation component is further configured to generate motion vectors for a decoded frame of a video sequence by applying a spatial coherence constraint that removes motion vector crossings to the motion vectors estimated for the blocks before estimating motion vectors for the sub-blocks.

18. The digital system of claim 15, wherein the motion vector generation component is further configured to generate motion vectors for a decoded frame of a video sequence by applying a spatial coherence constraint that removes vector crossings to the motion vectors estimated for the sub-blocks to generate spatially coherent motion vectors.

19. The digital system of claim 18, wherein applying a spatial coherence constraint comprises:
determining whether a horizontal crossing exists between a first motion vector and a second motion vector of the motion vectors estimated for the sub-blocks, wherein the first motion vector is a motion vector of a first sub-block and the second motion vector is a motion vector of a sub-block immediately to the left of the first sub-block;
when the horizontal crossing exists, modifying a horizontal component of the first motion vector or a horizontal component of the second motion vector to remove the horizontal crossing;
determining whether a vertical crossing exists between the first motion vector and a third motion vector, wherein the third motion vector is a motion vector of a sub-block immediately above the first sub-block; and
when the vertical crossing exists, modifying a vertical component of the first motion vector or a vertical component of the third motion vector to remove the vertical crossing.

20. The digital system of claim 15, further comprising:
a motion-compensated interpolation component configured to use the motion vectors estimated for the sub-blocks to interpolate frames in the video sequence.
